(19) United States
(12) Patent Application Publication
(10) Pub. No.: US 2022/0012348 A1
(43) Pub. Date: Jan. 13, 2022

(54) METHOD AND SYSTEM FOR MAINTAINING DIGITAL RIGHTS MANAGEMENT OF DATA FILES

(71) Applicants: Andrew Douglas Kirkwood, Houston, TX (US); Charles S. Knobloch, Katy, TX (US)

(72) Inventors: Andrew Douglas Kirkwood, Houston, TX (US); Charles S. Knobloch, Katy, TX (US)

(21) Appl. No.: 17/369,594

(22) Filed: Jul. 7, 2021

Related U.S. Application Data
(60) Provisional application No. 63/049,791, filed on Jul. 9, 2020.

(51) Int. Cl. G06F 21/62; G06F 21/31; G06F 21/10; G06F 21/60

(52) U.S. Cl. CPC G06F 21/6209; G06F 21/31; G06F 2221/0751; G06F 21/602; G06F 21/105

(57) ABSTRACT

A method for maintaining digital rights management of proprietary data files being used by third-party software applications on third-party computing hardware devices. A secure environment is established that restricts user access and input/output on a third-party computing device. It authenticates a user for access to the secure environment and authenticates the user for access to an encrypted file residing on a staging file store. The encrypted file is transferred, to the secure environment on the third-party computing device, and the user is authenticated for access to a decryption key to remove the encryption from the encrypted file. The decryption key is received and the encrypted file is decrypted. The user generates a new file from an analysis of the decrypted file, and the user is authenticated for access to an encryption key to encrypt the new file. The new encrypted file is transferred from the secure environment back to the staging file store.

### CLAIM OF PRIORITY

This application claims priority to provisional application Ser. No. 63/049,791 filed Jul. 9, 2020.

### TECHNICAL FIELD

Disclosed herein is a method and system for maintaining digital rights management of proprietary data files, regardless of their execution in third-party software applications on third-party computing devices. More particularly, this invention relates to maintaining the digital rights security and chain of custody history of proprietary oilfield data utilized in hydrocarbon resource exploration, development and management.

### BACKGROUND OF THE INVENTION

The oil & gas industry has been searching for commercial ways to maintain the security of proprietary data in light of the modern workforce, many of whom are independent geoscientists and engineers working at locations remote from the oil & gas industry offices. These independent geoscientists and engineers have their own computing hardware, making it difficult for the oil & gas industry companies to positively know that the propriety of their data is being maintained. Also, it is difficult for the oil & gas industry companies to meet their data licensing obligations to third-party data owners and to other partners who also have proprietary rights in the data. Thus, there is a long felt need in the oil & gas industry for a way to maintain digital rights management over data that resides on independent third-party computing hardware devices.

### BRIEF SUMMARY OF THE INVENTION

The present invention is a method for maintaining digital rights management of proprietary data files being used by third-party software applications on third-party computing hardware devices. A secure environment is established that restricts user access and input/output on a third-party computing device. It authenticates a user for access to the secure environment and authenticates the user for access to an encrypted file residing on a staging file store. The encrypted file is transferred to the secure environment on the third-party computing device, and the user is authenticated for access to a decryption key to remove the encryption from the encrypted file. The decryption key is received and the encrypted file is decrypted.

The user generates a new file from an analysis of the decrypted file, and the user is authenticated for access to an encryption key to encrypt the new file. The new encrypted file is transferred from the secure environment back to the staging file store.

These and other objects, features and advantages of the invention will be apparent and appreciated by reference to the following description of the preferred embodiments of the invention.

### BRIEF DESCRIPTION OF THE DRAWINGS

FIG. 1 is a schematic diagram illustrating an environment in which various examples of the invention presented herein are practiced;

FIG. 2 is a flowchart illustrating a method for maintaining digital rights management of proprietary data files being used by third-party software applications on third-party computing devices in accordance with examples of the present invention.

### DETAILED DESCRIPTION OF THE PREFERRED EMBODIMENTS OF THE INVENTION

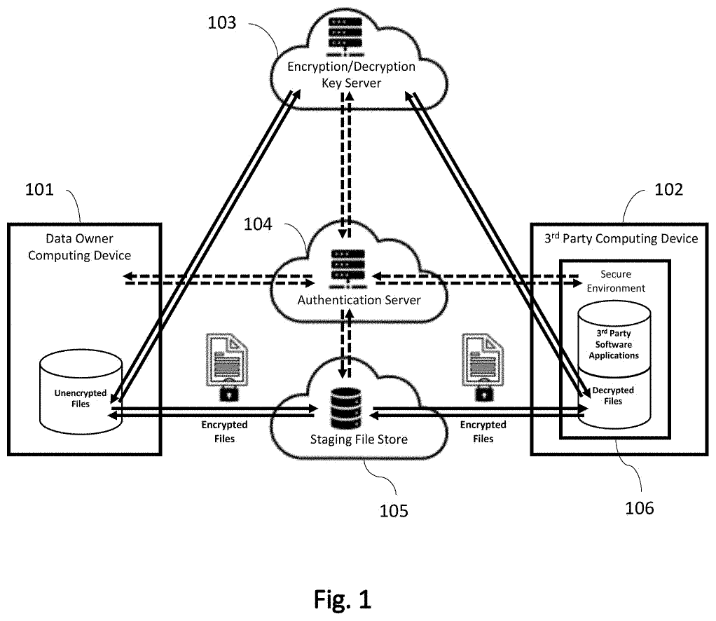

FIG. 1 is a schematic diagram illustrating an environment in which various examples of the invention presented herein are practiced. This involves a computing device 101 used by the owner (or an authorized representative of the owner) of the proprietary data file, a third-party computing device 102, a server 103 that provides encryption and decryption keys for encrypting and decrypting digitally rights-managed data files, a server 104 for authenticating and controlling user access, and a server 105 that serves as a staging area (temporary file store) that is used in the synchronization of digitally rights-managed data files between the data owner and third-party user of the data file. Data files refer to both files that contain digital data and files that contain reports (e.g. digital documents) on digital data. To initiate digital rights management of the proprietary data files, the data owner encrypts their proprietary data file on their computing device 101 to produce a digitally rights-managed version of it, and then transfers the digitally rights-managed data file to the staging file store 105.

To solve the problem of maintaining digital rights management of proprietary data files being used by third-party software applications on third-party computing devices, a secure environment 106 is established on the third-party computing device 102. An example of a secure environment is a disk drive (physical, partitioned, or virtual) with managed access rights and restricted input/output abilities. These environments may include their own disk operating systems and could be deployed as “virtual machines” or containers. In one example, access to the secure environment 106 is controlled by the owner of the proprietary data files and is approved, denied or terminated at the owner's discretion. The secure environment 106 is set up so that proprietary data files cannot be copied or moved from the secure environment 106. In one example, the secure environment 106 is set up so that third-party software applications are deployed in the secure environment 106 for the purpose of processing and analyzing propriety data files. In one example, new data tiles that are produced from the processing and analysis are considered as proprietary to the owner of the original data files. Therefore, the secure environment 106 restricts the output of these data files so that they can only be transferred back to the staging file store 105. In one example, the secure environment 106 is set up to generate a digital log that is used to monitor file activity in the secure environment 106 (e.g. transfer, decryption, encryption, deletion), as well as third-party software application activity in the secure environment 106 on the third-party computing device 102 (e.g. runtime, file access, file creation).

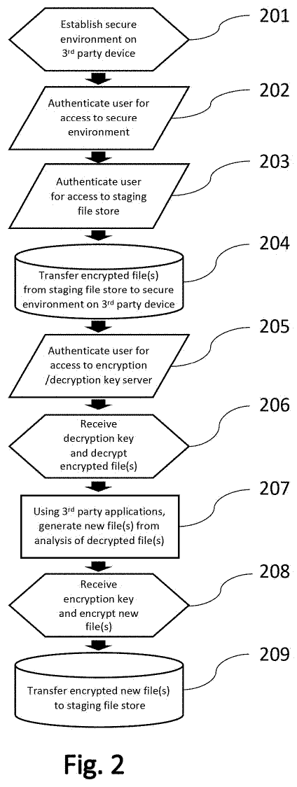

FIG. 2 is a flowchart illustrating a method for maintaining digital rights management of proprietary data files being used by third-party software applications on third-party computing devices in accordance with examples of the present invention. The method starts with the establishment 201 of a secure environment 106. After the secure environment 106 has been established, the user of the third-party device 102 is authenticated 202 to access the secure environment 106 by an authentication server 104. In one example, by using the authentication server 104, access to the secure environment 106 is controlled by the owner of the proprietary data files and is therefore approved, denied or terminated at the owner's discretion. Once the user is authenticated 202 for accessing the secure environment 106, the user is authenticated 203 for access rights to the staging file store 105.

In one example, by using the authentication server 104, access to the staging file store 105 is controlled by the owner of the proprietary data files and is therefore approved, denied or terminated at, the owner's discretion. Once the user has been granted access 203 to the staging file store 105, the user transfers 204 the digitally rights-managed data file, or a copy of the file, to the secure environment 106. In one example, in order to be able to process and analyze the digitally rights-managed data file in the secure environment 106, it needs to be decrypted. It should be noted that even after the data file has been decrypted, it is still being digitally rights-managed since the file cannot be copied or moved from the secure environment 106, and access to the secure environment 106 is controlled by the proprietary data owner. In one example, to decrypt the digitally rights-managed data file, the user is authenticated 205 to obtain a decryption key from an encryption/decryption key server 103. In one example, by using the authentication server 104, access rights to the encryption/decryption key server 103 is controlled by the owner of the proprietary data files and is therefore approved, denied or terminated at the owner's discretion. In other examples, multiple authentication servers are used to provide the authentication services 202, 203, 205. Once authenticated 205, the decryption key from the encryption/decryption key server 103 is retrieved and used to decrypt 206 the digitally rights-managed data file.

Once the digitally rights-managed data file has been decrypted 206, it is available to process and analyze 207 using third-party software applications. In one example of the invention, the owner of the proprietary data controls the use of third-party software applications in the secure environment 106 by authorizing access to the license files or keys that are needed to operate the software. Typically, when data files are processed or analyzed the result is to generate 207 new data files that contain digital data or contain reports (e.g. digital documents) on digital data. Because the new data files are based on the analysis and processing of proprietary data 207, they are generally considered proprietary to the original data file owner. Therefore, in one example, the new data files are digitally rights-managed by receiving an encryption key 208 from the encryption/decryption key server 103 to encrypt 208 any new data file. In one example, the encryption and decryption keys are the same key. Once a new data file has been encrypted, its digitally rights-managed status is maintained when it is transferred 209 to the staging file store 105. As discussed earlier in the invention description, the staging file store 105 is used in the synchronization of digitally rights-managed data files between the data owner and a third-party user of the data file. The data owner now has the option of transferring the new digitally rights-managed data file from the staging file store 105 to their computing device 101 for further review and analysis.

In one example, to decrypt the digitally rights-managed data file, the user is authenticated 205 to obtain a decryption key from an encryption/decryption key server 103.

Therefore, we claim:

1. A method for maintaining digital rights management of proprietary data files being used by third-party software applications on third-party computing hardware devices, comprising:

establishing a secure environment that restricts user access and input/output on a third-party computing device;

authenticating a user for access to the secure environment;

authenticating the user for access to an encrypted file residing on a staging file store;

transferring the encrypted file to the secure environment on the third-party computing device;

authenticating the user for access to a decryption key to remove the encryption from the encrypted file; and

receiving the decryption key and decrypting the encrypted file.

2. The method of claim 1 wherein:

the user generates a new file from an analysis of the decrypted file;

authenticating the user for access to an encryption key to encrypt the new file;

receiving the encryption key and encrypting the new file; and

transferring the encrypted new file from the secure environment back to the staging file store.

3. The method of claim 1 or claim 2 wherein authorization must be provided to allow the use of the third-party software application that is deployed in the secure environment on the third-party computing device.
4. The method of claim 1 or claim 2 or claim 3 wherein a digital log is generated for monitoring file use activity in the secure environment on the third-party computing device (e.g. transfer, decryption, encryption, deletion).
5. The method of claim 3 or claim 4 wherein a digital log is generated to monitor third-party software application activity in the secure environment on the third-party computing device (e.g. runtime, file access, file creation).

### CONCLUSION

As can be appreciated, the workflow steps herein described are reduced to practice through computer code that is executed on one or more computing devices.

Although the present invention is described herein with reference to a specific preferred embodiment(s), many modifications and variations therein will readily occur to those with ordinary skill in the art. Accordingly, all such variations and modifications are included within the intended scope of the present invention as defined by the reference numerals used.

From the description contained herein, the features of any of the examples, especially as set forth in the claims, can be combined with each other in any meaningful manner to form further examples and/or embodiments.

The foregoing description is presented for purposes of illustration and description and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to enable others skilled in the art to utilize the invention and such or other embodiments and with various modifications required by the particular applications or uses of the invention.

1. A method for maintaining digital rights management of proprietary data files being used by third-party software applications on third-party computing hardware devices, comprising:
establishing a secure environment that restricts user access and input/output on a third-party computing device;
authenticating a user for access to the secure environment;
authenticating the user for access to an encrypted file residing on a staging file store;
transferring the encrypted file to the secure environment on the third-party computing device;
authenticating the user for access to a decryption key to remove the encryption from the encrypted file; and
receiving the decryption key and decrypting the encrypted file,

2. The method of claim 1 wherein:
the user generates a new file from an analysis of the decrypted file;
authenticating the user for access to an encryption key to encrypt the new file;
receiving the encryption key and encrypting the new file; and
transferring the encrypted new file from the secure environment back to the staging file store.

3. The method of claim 2 wherein authorization must be provided to allow the use of the third-party software application that is deployed in the secure environment on the third-party computing device.

4. The method of claim 3 wherein a digital log is generated for monitoring file use activity in the secure environment on the third-party computing device (e.g. transfer, decryption, encryption, deletion).

5. The method of claim 4 wherein a digital log is generated to monitor third-party software application activity in the secure environment on the third-party computing device (e.g. runtime, file access, file creation).

6. The method of claim 3 wherein a digital log is generated to monitor third-party software application activity in the secure environment on the third-party computing device (e.g. runtime, file access, file creation).

7. The method of claim 2 wherein a digital log is generated for monitoring file use activity in the secure environment on the third-party computing device (e.g. transfer, decryption, encryption, deletion).

8. The method of claim 1 wherein a digital, log is generated for monitoring file use activity in the secure environment on the third-party computing device (e.g. transfer, decryption, encryption, deletion).

9. The method of claim 1 wherein authorization must be provided to allow the use of the third-party software application that is deployed in the secure environment on the third-party computing device.
